(19) United States
(12) Patent Application Publication
(10) Pub. No.: US 2026/0206044 A1
(43) Pub. Date: Jul. 16, 2026

(54) VEHICLE

(71) Applicant: TOYOTA JIDOSHA KABUSHIKI KAISHA, Toyota-shi (JP)

(72) Inventors: Noriaki ITO, Toyota-shi (JP); Shingo SUGIMOTO, Nagoya-shi (JP); Yuma ITO, Chiryu-shi (JP)

(73) Assignee: TOYOTA JIDOSHA KABUSHIKI KAISHA, Toyota-shi (JP)

(21) Appl. No.: 19/396,063

(22) Filed: Nov. 20, 2025

(30) Foreign Application Priority Data
Jan. 14, 2025 (JP) 2025-005009

(51) Int. Cl. H04W 72/27; H04W 4/44

(52) U.S. Cl. CPC H04W 72/27; H04W 4/44

(57) ABSTRACT

The vehicle includes a first communication device and a second communication device. The first communication device provides one or more first communication channels as a first access point. The second communication device is connected to the second access point via a second communication channel. The first communication device or the second communication device performs control so that the frequency bands of the one or more first communication channels and the frequency bands of the second communication channel do not overlap with each other.

### CROSS-REFERENCE TO RELATED APPLICATION

This application claims priority to Japanese Patent Application No. 2025-005009 filed on January 14, 2025. The disclosure of the above-identified application, including the specification, drawings, and claims, is incorporated by reference herein in its entirety.

### BACKGROUND

### 1. Technical Field

The present disclosure relates to a vehicle.

### 2. Description of Related Art

Conventionally, there is known a technique of selecting a desired network interface, from a plurality of network interfaces for communication between a plurality of vehicles, based on a wireless measurement score (Japanese Unexamined Patent Application Publication No. 2022-159229 (JP 2022-159229 A)).

### SUMMARY

A vehicle is occasionally equipped with a multimedia device such as a navigational device and a communication device dedicated to the vehicle such as a data communication module (DCM). The multimedia device functions as an access point that provides a wireless local area network LAN) to a terminal device or the like of a user of the vehicle. The communication device dedicated to the vehicle is occasionally connected to an access point outside the vehicle through a wireless LAN. In this case, electromagnetic waves of the wireless LAN to which the terminal device or the like of the user is connected may interfere with electromagnetic waves of the wireless LAN to which the communication device dedicated to the vehicle is connected.

In view of the foregoing, an object of the present disclosure is to reduce interference of electromagnetic waves of wireless LANs in a vehicle.

An aspect of the present disclosure provides a vehicle including: a first communication device that provides one or more first communication channels as a first access point; and a second communication device connected to a second access point through a second communication channel, in which the first communication device receives information on a frequency band of the second communication channel from the second communication device, selects one or more communication channels in a frequency band that is different from the frequency band of the second communication channel received, from among one or more communication channels that the first communication device is able to provide, and provides the selected one or more communication channels as the one or more first communication channels, or the second communication device receives information on a frequency band of the one or more first communication channels from the first communication device, and selects, as the second communication channel, a communication channel in a frequency band that is different from the frequency band of the one or more first communication channels received, from among one or more communication channels provided by the second access point.

An aspect of the present disclosure provides a vehicle including: a first communication device that provides one or more first communication channels as a first access point; and a second communication device connected to a second access point through a second communication channel, in which the first communication device or the second communication device performs control such that a frequency band of the one or more first communication channels and a frequency band of the second communication channel do not overlap each other.

According to an embodiment of the present disclosure, it is possible to reduce interference of electromagnetic waves of wireless LANs in a vehicle.

### BRIEF DESCRIPTION OF THE DRAWINGS

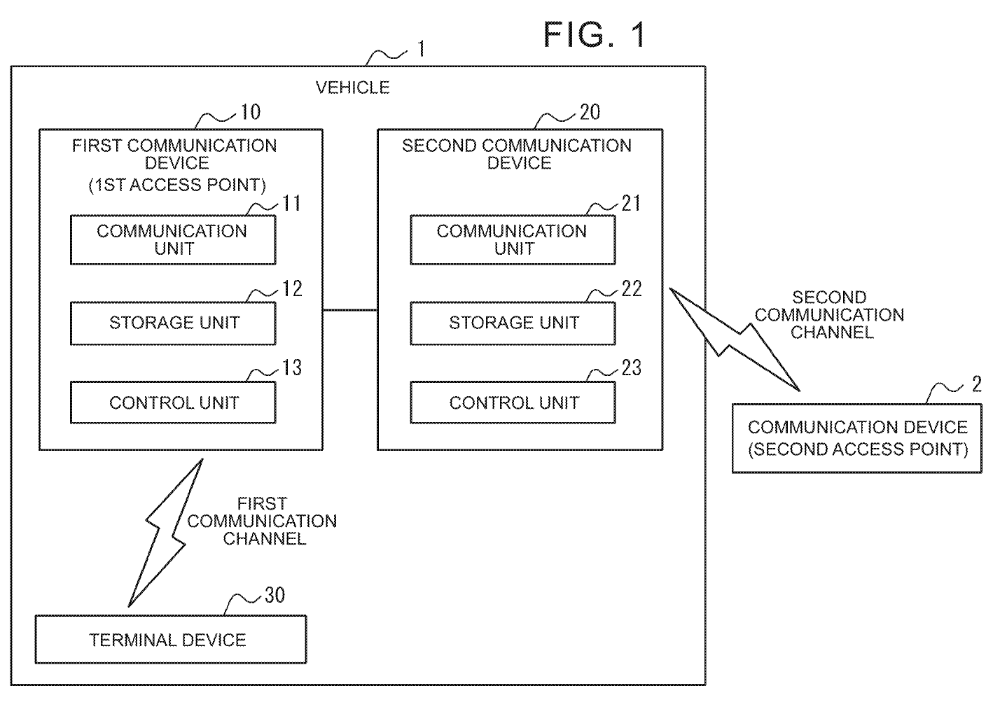

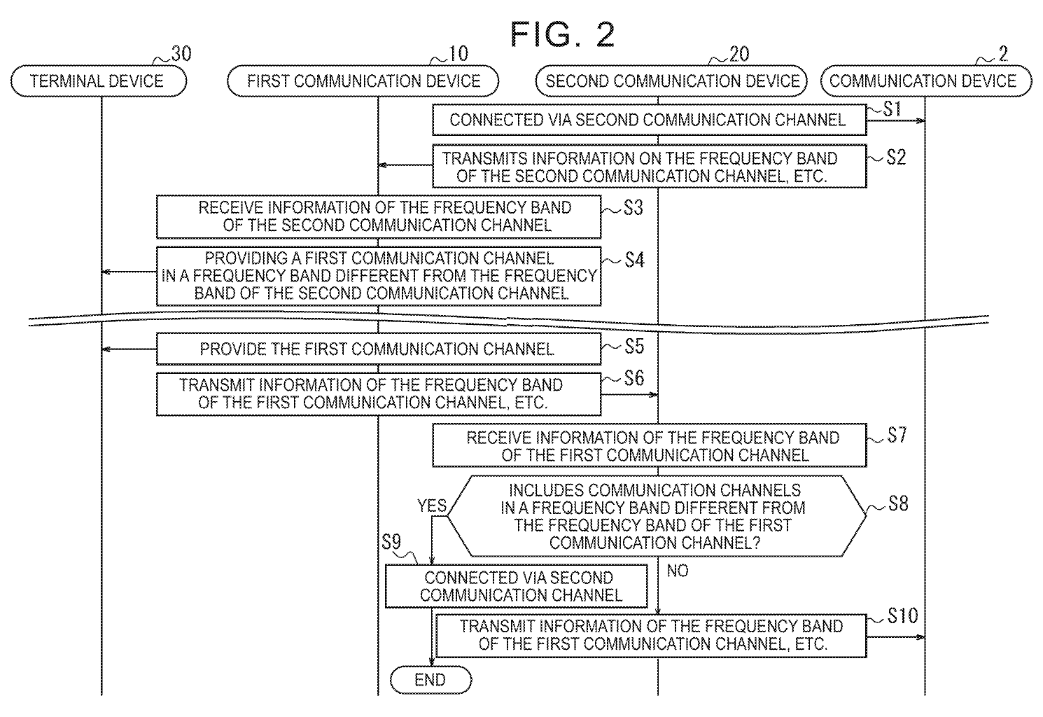

Features, advantages, and technical and industrial significance of exemplary embodiments of the disclosure will be described below with reference to the accompanying drawings, in which like signs denote like elements, and wherein: FIG. 1 is a diagram illustrating a schematic configuration of a vehicle according to an embodiment of the present disclosure; and FIG. 2 is a sequence diagram illustrating an example of the operation of the vehicle illustrated in FIG. 1.

### DETAILED DESCRIPTION OF EMBODIMENTS

Hereinafter, an embodiment of the present disclosure will be described below with reference to the drawings. In the present embodiment described below, the access point providing a communication channel means that the access point transmits and receives electromagnetic waves of the communication channel. When the access point transmits and receives the electromagnetic waves of the communication channel, the terminal device becomes connectable to the access point through the communication channel.

As illustrated in FIG. 1, a vehicle 1 according to an embodiment of the present disclosure includes a first communication device 10, a second communication device 20, and a terminal device 30. The number of terminal devices 30 included in the vehicle 1 illustrated in FIG. 1 is one. However, the vehicle 1 may include a plurality of terminal devices 30. The terminal device 30 is, for example, a terminal device such as a smartphone of a user of the vehicle 1. The first communication device 10 and the second communication device 20 are connected to each other so as to be able to communicate with each other by wire or wirelessly.

The first communication device 10 is, for example, a multimedia device such as a navigation device. The first communication device 10 is a first access point that provides one or more communication channels of a wireless LAN. A standard of the wireless LAN according to the present embodiment is, for example, Wi-Fi (registered trademark). Hereinafter, the communication channel provided by the first communication device 10 as the first access point is referred to as a "first communication channel". The first communication device 10 provides one or more first communication channels. That is, the first communication device 10 transmits and receives electromagnetic waves of one or a plurality of first communication channels. The plurality of first communication channels has different frequency bands. The first communication device 10 selects one or more communication channels from among the one or more communication channels that can be provided. The first communication device 10 provides the selected one or more communication channels as one or more first communication channels. For example, the first communication device 10 scans the electromagnetic wave intensity around the first communication device 10 by the communication unit 11 described later. Then, the first communication device 10 selects one or more communication channels with less interference from among the one or more communication channels that can be provided, and provides the selected one or more communication channels as the one or more first communication channels. The terminal device 30 selects, from among the one or more first communication channels provided by the first communication device 10, a first communication channel to be used for connection to the first communication device 10 that is the first access point. The terminal device 30 executes a connection process for establishing a connection between the terminal device 30 and the first communication device 10 via the selected first communication channel, as described later.

The second communication device 20 is, for example, a vehicle-specific communication device such as a DCM. The second communication device 20 connects to the second access point via one or more communication channels of a wireless LAN provided by the second access point. In the present embodiment, the second access point is the communication device 2 outside the vehicle 1. The communication device 2 is, for example, a communication device at a user's home of the vehicle 1 or a communication device mounted on another vehicle. Hereinafter, a communication channel used by the second communication device 20 to connect to the communication device 2 among the one or more communication channels provided by the communication device 2 in the second access point, that is, the present embodiment, is referred to as a "second communication channel". The communication device 2 may select one or more communication channels to be provided from among one or more communication channels that can be provided, the same as or similar to the first communication device 10. The second communication device 20 selects a second communication channel to be used for connection to the communication device 2 from among one or more communication channels provided by the communication device 2. The second communication device 20 executes a connection process for establishing a connection between the second communication device 20 and the communication device 2 via the selected second communication channel, as will be described later.

The first communication device 10 includes a communication unit 11, a storage unit 12, and a control unit 13. The second communication device 20 includes a communication unit 21, a storage unit 22, and a control unit 23. The communication unit 11 and the communication unit 21 are each configured to include a first communication module corresponding to a standard of a wireless LAN such as Wi-Fi. The communication unit 11 and the communication unit 21 may each include a second communication module corresponding to a communication standard between the first communication device 10 and the second communication device 20. The second communication module is a communication module compliant with a standard of an in-vehicle network such as CAN (Controller Area Network). The communication unit 11 and the communication unit 21 may each include a third communication module connectable to a mobile communication network. The third communication module is, for example, a communication module compatible with a mobile communication standard such as 4G or 5G. Each of the storage unit 12 and the storage unit 22 includes at least one semiconductor memory or the like. The storage unit 12 stores data used for the operation of the first communication device 10 and data obtained by the operation of the first communication device 10. The storage unit 12 may store a program to be executed by the control unit 13. The storage unit 22 stores data used for the operation of the second communication device 20 and data obtained by the operation of the second communication device 20. The storage unit 22 may store a program to be executed by the control unit 23. The control unit 13 and the control unit 23 each include at least one processor. The processor is, for example, a general-purpose processor such as a CPU or a special-purpose processor specialized for a particular process. The control unit 13 executes processing related to the operation of the first communication device 10 while controlling each unit of the first communication device 10. The control unit 23 executes processing related to the operation of the second communication device 20 while controlling each unit of the second communication device 20.

FIG. 2 is a sequence diagram illustrating an example of the operation of the vehicle 1 illustrated in FIG. 1. S10 may be executed earlier from S5 than from S1 to S4. S1 to S4 and S5 to S10 may be executed at different timings.

In the second communication device 20, the control unit 23 executes a connection process for establishing a connection between the second communication device 20 and the communication device 2, which will be described later in S9, and thereby causes the communication unit 21 to be connected to the communication device 2 via the second communication channel (S1). After S1 is processed, the second communication device 20 is connected to the second access point, i.e., the communication device 2, via the second communication channel. The control unit 23 transmits the information of the frequency band of the second communication channel and the first signal to the first communication device 10 by the communication unit 21 (S2). The first signal is a signal indicating that the second communication device 20 is connected to the second access point.

In the first communication device 10, the control unit 13 receives, by the communication unit 11, the information of the frequency band of the second communication channel and the first signal from the second communication device 20 (S3). At the time of S3, the first communication device 10 may be providing the first communication channel or may not be providing the first communication channel. The control unit 13 selects one or more communication channels of a frequency band that differs from the frequency band of the second communication channel received by S3 among the plurality of communication channels that can be provided by the first communication device 10. The control unit 13 provides the selected one or more communication channels as one or more first communication channels (S4). After S4 is processed, the terminal device 30 selects the first communication channel to be used for connecting to the first communication device 10 from among the one or more first communication channels provided by the first communication device 10. The terminal device 30 transmits, to the first communication device 10, at least one of setting information and a processing signal used in connection processing for establishing a connection between the terminal device 30 and the first communication device 10 via the selected first communication channel. The connecting process is based on an authentication method or the like set in advance in a wireless LAN such as Wi-Fi. The connecting process includes, for example, an authenticating process such as WPA (Wi-Fi Protected Access) 2 or WPA3 and an associating process. The setting information is, for example, a MAC address. The processing signal is, for example, a signal for an authentication request or a signal for an association request. The control unit 13 of the first communication device 10 receives at least one of the setting information and the processing signal from the terminal device 30 via the first communication channel selected by the terminal device 30 by the communication unit 11. Upon receiving at least one of the setting information and the processing signal, the control unit 13 executes the above-described connection processing between the first communication device 10 and the terminal device 30. When the connection processing is completed, a connection is established between the terminal device 30 and the first communication device 10. By establishing a connection between the terminal device 30 and the first communication device 10, the terminal device 30 is in a state of being connected to the first communication device 10.

From this S1, S4 enables the vehicles 1 to execute the following processes. That is, the second communication device 20 may be connected via the second communication channel. In this case, the first communication device 10 provides one or more first communication channels of a frequency band different from the frequency band of the second communication channel among the one or more communication channels that the first communication device 10 can provide. With such a configuration, it is possible to reduce the interference of the electromagnetic waves of the wireless LAN in the vehicles 1. The terminal device 30 is connected to the first communication device 10 through a first communication channel in a frequency band different from the frequency band of the second communication channel. Furthermore, when the second communication device 20 is connected via the second communication channel, it is not necessary to change the frequency band of the second communication channel. With such a configuration, it is possible to maintain the connection between the second communication device 20 and the communication device 2.

In the first communication device 10, the control unit 13 provides one or more first communication channels by the communication unit 11 (S5). After S5 is processed, the first communication device 10 is ready to provide one or more first communication channels. The control unit 13 transmits, by the communication unit 11, the information of the frequency bands of the one or more first communication channels and the second signal to the second communication device 20 (S6). The second signal is a signal indicating that the first communication device 10 is providing one or more first communication channels.

In the second communication device 20, the control unit 23 receives, by the communication unit 21, the information of the frequency bands of one or more first communication channels and the second signal from the first communication device 10 (S7). The control unit 23 determines whether or not the one or more communication channels provided by the communication device 2 include a communication channel in a frequency band that differs from the frequency band of the one or more first communication channels received in S7 (S8). Here, at the time of S8, the second communication device 20 may be connected to the communication device 2 via the second communication channel, or may not be connected to the communication device 2 via the second communication channel. When the second communication device 20 is connected to the communication device 2 in the second communication channel at S8 time point, the one or more communication channels provided by the communication device 2 in the determination of S8 include the second communication channel. When the control unit 23 determines that the one or more communication channels provided by the communication device 2 include a communication channel in a frequency band that differs from the frequency band of the one or more first communication channels received in S7 (S8: YES), S9 proceeds. When the control unit 23 determines that the one or more communication channels provided by the communication device 2 do not include a communication channel in a frequency band that differs from the frequency band of the one or more first communication channels received in S7 (S8: NO), S10 proceeds.

In S9, the control unit 23 selects a communication channel of a frequency band that differs from the frequency band of the first communication channel among one or a plurality of second communication channels provided by the communication device 2. The control unit 23 sets the selected communication channel as the second communication channel. The control unit 23 transmits, via the selected second communication channel, at least one of connection information and a processing signal used in connection processing for establishing a connection between the second communication device 20 and the communication device 2 to the communication device 2 by the communication unit 21. The connecting process, the setting information and the processing signal are the same as or similar to those described above in S4. In the same or similar manner as described above, upon receiving at least one of the setting information and the processing signal, the communication device 2 executes a connection process between the second communication device 20 and the communication device 2. When the connection processing is completed, a connection is established between the second communication device 20 and the communication device 2. By establishing a connection between the second communication device 20 and the communication device 2, the second communication device 20 is in a state of being connected to the communication device 2. However, when the communication unit 21 is connected to the communication device 2 in the second communication channel different from the frequency band of the first communication channel at S9 time point, the control unit 23 may only maintain the connection in the second communication channel in S9. After S9 process, the vehicle 1 ends the process.

From such a S5, the following process is executed by S9 in the vehicle 1. The second communication device 20 may be providing one or more first communication channels by the first communication device 10. In this case, a communication channel in a frequency band different from the frequency band of the first communication channel is selected as the second communication channel from among one or more communication channels provided by the communication device 2. With such a configuration, it is possible to reduce the interference of the electromagnetic waves of the wireless LAN in the vehicles 1. Further, the first communication device 10 does not need to change the frequency band of the provided first communication channel. Thus, when the terminal device 30 is connected to the first communication device 10 via the first communication channel, the connection between the terminal device 30 and the first communication device 10 can be maintained.

In S10, the control unit 23 transmits, by the communication unit 21, the information of the frequency bands of the one or more first communication channels and the third signal received by S7 to the communication device 2. The third signal is a signal that instructs the second access point, i.e., the communication device 2, to change the frequency band of the communication channel provided by the communication device 2. In S10, the control unit 23 may transmit, by the communication unit 21, one of the information of the frequency band of the first communication channel and the third signal to the communication device 2. When receiving the information of the frequency bands of the one or more first communication channels or the like, the communication device 2 changes the frequency band of the provided communication channel to a frequency band different from the frequency band of the received one or more first communication channels. By changing the frequency band of the communication channel provided by the communication device 2 in this way, in the second communication device 20, the control unit 23 can connect the communication unit 21 to the communication device 2 through the second communication channel having a frequency band different from the frequency band of the first communication channel.

### Other cases of S2

In another embodiment of S2, the control unit 13 of the first communication device 10 transmits, by the communication unit 11, a request signal requesting information of the frequency band of the second communication channel to the second communication device 20. Upon receiving the request signal from the first communication device 10 by the communication unit 21, the control unit 23 of the second communication device 20 transmits the information of the frequency band of the second communication channel to the first communication device 10 by the communication unit 21. The control unit 13 of the first communication device 10 receives the information of the frequency band of the second communication channel from the second communication device 20 by the communication unit 11.

### Other cases of S4

In another embodiment of S4, the control unit 13 of the first communication device 10 scans an electromagnetic wave of a wireless LAN around the first communication device 10 by the communication unit 11. In some cases, the second communication device 20 is connected to the communication device 2 via the second communication channel. In this case, the control unit 13 can acquire the information of the frequency band of the second communication channel by scanning the electromagnetic wave of the wireless LAN around the first communication device 10 by the communication unit 11. In this case, in S2, the control unit 23 of the second communication device 20 may transmit only the first signal to the first communication device 10 by the communication unit 11. In S3, the control unit 13 of the first communication device 10 may receive only the first signal from the second communication device 20 by the communication unit 21. Alternatively, S2 and S3 processes may not be performed. The control unit 13 selects one or a plurality of communication channels of a frequency band different from the frequency band of the second communication channel acquired by scanning among the plurality of communication channels that can be provided by the first communication device 10. The control unit 13 provides the selected one or more communication channels as one or more first communication channels.

As described above, in the present embodiment, the first communication device 10 or the second communication device 20 performs control so that the frequency bands of the one or more first communication channels and the frequency bands of the second communication channels do not overlap with each other. With such a configuration, it is possible to reduce the interference of the electromagnetic waves of the wireless LAN in the vehicles 1.

Although the present disclosure has been described above based on the drawings and the embodiment, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

For example, in S2, the control unit 23 of the second communication device 20 may transmit one of the frequency band information of the second communication channel and the first signal to the first communication device 10 by the communication unit 21. In S3, the control unit 13 of the first communication device 10 receives, from the second communication device 20, one of the information of the frequency band of the second communication channel and the first signal. For example, in S6, the control unit 13 of the first communication device 10 may transmit, by the communication unit 11, one of the frequency band information of the first communication channel and the second signal to the second communication device 20. In this case, the control unit 23 of the second communication device 20 receives, by the communication unit 21, any one of the information of the frequency bands of one or more first communication channels and the second signal from the first communication device 10.

What is claimed is:

1. A vehicle comprising:
a first communication device that provides one or more first communication channels as a first access point; and
a second communication device connected to a second access point through a second communication channel, wherein
the first communication device receives information on a frequency band of the second communication channel from the second communication device, selects one or more communication channels in a frequency band that is different from the frequency band of the second communication channel received, from among one or more communication channels that the first communication device is able to provide, and provides the selected one or more communication channels as the one or more first communication channels,
or
the second communication device receives information on a frequency band of the one or more first communication channels from the first communication device, and selects, as the second communication channel, a communication channel in a frequency band that is different from the frequency band of the one or more first communication channels received, from among one or more communication channels provided by the second access point.

2. A vehicle comprising:
a first communication device that provides one or more first communication channels as a first access point; and
a second communication device connected to a second access point through a second communication channel, wherein
the first communication device or the second communication device performs control such that a frequency band of the one or more first communication channels and a frequency band of the second communication channel do not overlap each other.

3. The vehicle according to claim 2, wherein when the second communication device is connected to the second access point through the second communication channel, the first communication device selects one or more communication channels in a frequency band that is different from the frequency band of the second communication channel, among one or more communication channels provided by the first communication device, and provides the selected one or more communication channels as the one or more first communication channels.

4. The vehicle according to claim 3, wherein the first communication device receives, from a terminal device, at least one of setting information and a processing signal to be used in a connection process for establishing a connection between the terminal device and the first communication device via a first communication channel selected by the terminal device from the one or more first communication channels.

5. The vehicle according to claim 2, wherein when the first communication device provides the one or more first communication channels, the second communication device selects, as the second communication channel, a communication channel in a frequency band that is different from the frequency band of the one or more first communication channels, from among one or more communication channels provided by the second access point.

6. The vehicle according to claim 5, wherein the second communication device transmits, to the second access point, at least one of setting information and a processing signal to be used in a connection process for establishing a connection between the second communication device and the second access point via the second communication channel.
